(19) United States
(12) Patent Application Publication
(10) Pub. No.: US 2014/0361078 A1
(43) Pub. Date: Dec. 11, 2014

(54) OVERHEAD ANTENNA LIVE INVENTORY LOCATING SYSTEM

(71) Applicant: BAR CODE SPECIALTIES, INC.(DBA BCS Solutions), Garden Grove, CA (US)

(72) Inventor: William Edward Davidson, Durham, NC (US)

(21) Appl. No.: 14/466,336

(22) Filed: Aug. 22, 2014

Related U.S. Application Data
(63) Continuation of application No. PCT/US2013/026835, filed on Feb. 20, 2013.
(60) Provisional application No. 61/601,976, filed on Feb. 22, 2012.

(51) Int. Cl. G06K 7/10; G06Q 10/08

(52) U.S. Cl. CPC G06K 7/10475; G06Q 10/087
USPC 235/385; 29/601

(57) ABSTRACT

Overhead antenna live inventory locating systems and methods are provided. The overhead antenna inventory/locating system can include a plurality of antennas mounted in an elevated support structure. The antennas can be coupled to RFID readers that interrogate electronic tags. The inventory system can analyze the information received from the detected electronic tags and produce inventory data and location information for the tags. The antennas can be patch antennas mounted to ceiling tiles such that they can be positioned in the ceiling of a facility. The antennas can be configured to provide broad coverage from a relatively low ceiling height. The low-cost antennas can be configured in such a way as to provide accurate location information for detected tags. The inventory system can be configured to provide near real-time inventory and location information.

### CROSS-REFERENCE TO RELATED APPLICATIONS

This application is a continuation of Patent Cooperation Treaty Application No. PCT/US2013/026835, filed Feb. 20, 2013, entitled “OVERHEAD ANTENNA LIVE INVENTORY LOCATING SYSTEM,” which claims the benefit of priority under 35 U.S.C. §119(e) of U.S. Provisional Patent Application 61/601,976, filed Feb. 22, 2012, entitled “OVERHEAD ANTENNA LIVE INVENTORY LOCATING SYSTEM,” the entire contents of both of which are hereby incorporated by reference herein and made a part of this specification for all that they disclose.

### BACKGROUND

1. Field

The disclosure relates generally to inventory systems and methods, and more particularly to inventory systems and methods for reading electronic tags.

2. Description of Related Art

A common challenge in many businesses is keeping track of inventory. This challenge is especially intense when there is high product volume, a diverse product line, and multiple sources of product movement or inventory change. In recent years, electronic systems have helped to address this challenge. For example, inventory tracking has been aided by attaching small electronic tracking devices to products that can permit an electronic system to obtain inventory information about the products.

In some systems, these electronic tracking devices comprise radio-frequency identification (RFID) technology. RFID devices use radio waves to transfer data from an electronic tag, called an RFID tag or label, to an RFID reader. The RFID tag may be attached to an object for the purpose of identifying and tracking the object to which the RFID tag is attached. Generally, the RFID tag includes a small radio frequency (RF) transmitter and receiver. An RFID reader transmits an encoded radio signal to interrogate the tag. The tag receives the message and responds with its identification information, which is stored electronically. Many RFID tags do not use a battery or external power source. Instead, the tag, known as a passive RFID tag, uses the electromagnetic energy transmitted by the reader as its energy source. For example, a passive RFID tag reflects the reader's transmission back to the reader and modulates that reflection. The RFID system design can include features for discriminating between several tags that might be within the range of the RFID reader.

### SUMMARY

The systems, methods and devices of the disclosure each have innovative aspects, no single one of which is solely responsible for the desirable attributes disclosed herein. Without limiting the scope of the claims, some of the advantageous features will now be summarized.

Conducting an assessment of inventory of RFID-tagged items can be performed by a person using a handheld RFID reader. In this process, the person moves through the store and uses the handheld reader to detect the RFID-tagged items. However, this method of inventorying electronic tags has a margin of error due to the manual nature of the operation. For example, a worker moving through a storage facility with an RFID reader can miss inventorying particular areas due to mistake, becoming distracted during the operation, forgetting about areas, or rushing to finish the operation. In addition, a worker performing an inventory operation in this manner does not record the location of the items. Moreover, manual inventorying of electronic tags does not provide a real-time inventory of the store and can be an inefficient use of time, money, and resources. The amount of time required for such an operation may be increased due to procedural requirements as well. Finally, manually inventorying a store in this fashion may interfere with the normal course of operations of the store or warehouse.

Automated systems for detecting electronic inventory tags can be used to provide consistent results and near real-time inventory information. Automated systems can utilize arrays of overhead readers and exciters, arrays of overhead bidirectional phased array systems and/or smart shelving and smart hanging rails. These automated systems can, to varying degrees, give the location of any given item in the store.

However, some overhead automated systems may cost significantly more than a handheld reader and a full time clerk even for comparatively small facilities. Some types of automated systems do not scale well, with costs climbing rapidly as the store size and population of items grows. Some automated systems can also require considerable setup and infrastructure to install, which is expensive, and can conflict with the store's decor. In some cases the system may need to be re-installed or calibrated if the store display scheme is changed significantly, once again increasing the cost to run and maintain the system.

Inventory systems that include overhead antennas and readers to read RFID tags may not provide location information beyond a determination that the item is located within a predefined zone. In systems that utilize a single antenna to cover a particular area of a store, the location information is limited to determining the presence of the tagged article in that area. This area may be of considerable size, depending on the range of the antenna. Additionally, if the tag is shielded from the reader's transmitted signal, the tag may not be read at all. Inventory systems that monitor a passageway or “choke point,” such as a door, hallway, entryway, or the like, may provide location information in the form of whether a tagged article has passed the choke point. However, there may be ambiguity as to whether the article entered or exited the monitored choke point. Moreover, choke points do not provide real-time location information, but instead imply a location based on the direction of motion of the tag and the time the tag passed the choke point. For example, a tagged item can be inferred as being in room A if it was last detected moving through a choke point in the direction of room A.

Some overhead inventory systems can be less effective when installed in a ceiling because they require a minimum height in order to operate effectively. For example, some antennas require structures that are too big to fit above a ceiling and would impede the operation of the store if mounted on the ceiling but facing toward the ground. As another example, some systems that use phased arrays can require about ten feet for the wave front to form before being able to reliably detect an RFID tag. Moreover, some phased arrays can have an antenna beam angle that defines a cone that covers a smaller and smaller area as the distance to the antenna decreases. In stores with low ceilings or where inventory is located close to the ceiling, this may exclude many items from the field of view of the antenna, and other antennas may be required to obtain complete coverage thereby increasing the cost of the system. Although some of these issues can be mitigated by a carefully designed installation or by adding more antennas to the automated reading system, these solutions can further increase the cost of these systems.

Therefore, in some embodiments a low-cost automated inventory and localizing system can provide acceptable effectiveness, provide real-time inventory and location information, and resist interference with normal store operations. In some implementations, an overhead antenna inventory/locating system can include a plurality of antennas mounted in an elevated support structure. The antennas can be coupled to RFID readers that interrogate electronic tags. The inventory system can analyze the information received from the detected electronic tags and produce inventory data and location information for the tags. The antennas can be patch antennas mounted in or near a ceiling (such as in or on ceiling tiles). In some embodiments, the antennas can be configured to provide broad coverage from a relatively low ceiling height, are relatively low-cost, and can be configured in such a way as to provide accurate location information for detected tags. The inventory system can be configured to provide near real-time inventory and location information.

In some embodiments, the electronic tags are passive RFID tags. Passive RFID tags can be more cost effective than tags that utilize batteries or other power sources, such as active RFID tags. In general, a passive RFID tag is cheaper than a corresponding active RFID tag and may require less maintenance. Configuring the overhead antenna system to function with passive RFID tags can reduce the overall cost of implementing the system where passive RFID tags are currently being used. Thus, providing real-time inventory and location information for passive RFID tags can be a cost-effective and practical solution to inventory and locating needs.

In some implementations, the overhead antennas can be patch antennas. The patch antennas can be mounted in a support structure over a storage area, warehouse, retailer facility, or the like. In some implementations, a patch antenna can be mounted to a ceiling tile for installation in the ceiling. In some implementations, the overhead antennas can be steerable antennas. In some implementations, the antennas can produce circularly polarized electromagnetic radiation. In some implementations, the antennas can emit signals with a frequency of at least about 902 MHz or less than or equal to about 928 MHz. In some implementations, the antennas can emit a frequency that changes about every 400 ms or less. In some implementations, the antennas can emit a frequency that changes about every 10 s or less, or a frequency that changes about every 4 s or less.

In some implementations, the system can be configured to perform near real-time location determination of detected tags and/or inventory evaluation. The location determination can be performed using trilateration techniques, triangulation techniques, or using a single steerable antenna. Location information can be communicated to a system that stores the information, communicates the information over a network, and/or analyzes the information. The location information for the RFID tags can provide information related to the inventory of the store. This information can be utilized to determine, for example, the need for more items, the location of misplaced items, detection of possible theft, or any combination of these.

In a first aspect, a system is provided for locating and identifying a plurality of inventory items, each inventory item being associated with an RFID tag. The system can include at least one RFID reader configured to generate RFID interrogation signals and receive RFID response signals. The system can include a plurality of antennas positioned in an overhead support structure and coupled to the at least one RFID reader. Each of the plurality of antennas can be configured to receive from the at least one RFID reader an RFID interrogation signal, transmit a radio-frequency interrogation signal in response to the received RFID interrogation signal, receive from one or more RFID tags a radio-frequency response signal, and send to the at least one RFID reader an RFID response signal in response to the received radio-frequency response signal. The system can include an inventory module coupled to the at least one RFID reader, the inventory module configured to identify, based at least partly on the RFID response signal, each inventory item associated with an RFID tag that generated the radio-frequency response signal that was received by at least one of the plurality of antennas. The system can include a location module coupled to the at least one RFID reader, the location module configured to determine, based at least partly on the RFID response signal, a location of each inventory item associated with an RFID tag that generated a radio-frequency response signal that was received by at least one of the plurality of antennas.

In some embodiments of the first aspect, the system can include a tracking module coupled to the inventory module and the location module, the tracking module being configured to track a location of each of the inventory items based at least partly on identification information received from the inventory module and location information received from the location module. In a further embodiment, the tracking module can be configured to provide a location of each of the inventory items as a function of time.

In some embodiments of the first aspect, the plurality of antennas can comprise patch antennas. In some embodiments of the first aspect, the plurality of antennas can comprise phased arrays. In some embodiments of the first aspect, the plurality of antennas transmit circularly polarized radiation.

In some embodiments of the first aspect, the radio-frequency interrogation signal can have a frequency that is in a range between about 902 MHz and 928 MHz. In some embodiments of the first aspect, the radio-frequency interrogation signal can have a frequency that is in a range between about 865 MHz and 870 MHz.

In some embodiments of the first aspect, the plurality of antennas can be configured to transmit RF signals that change frequency every 400 ms or less. In some embodiments of the first aspect, the plurality of antennas can be configured to transmit RF signals that change frequency every 4 s or less.

In some embodiments of the first aspect, the overhead support structure can include a ceiling. In a further embodiment, the plurality of antennas can be mounted to ceiling tiles in the ceiling.

In some embodiments of the first aspect, the at least one RFID reader is coupled to the plurality of antennas through a multiplexor.

In a second aspect, a method is provided for determining a location of an inventory item associated with an RFID tag using an inventory system wherein the inventory system comprises an RFID reader configured to receive multiple readings from RFID tags associated with inventory items, the RFID reader being coupled to a plurality of antennas configured to transmit and receive signals to and from the RFID reader and RFID tags, and an inventory module configured to identify the inventory items based at least partly on the received signals from the RFID tags. The method can include selecting a first antenna which has received signals from the RFID tag associated with the inventory item. The method can include retrieving first information associated with the RFID tag from the RFID reader coupled to the first antenna. The method can include calculating a first range from the first antenna to the RFID tag based on the first information. The method can include selecting a second antenna which has received signals from the RFID tag associated with the inventory item. The method can include retrieving second information associated with the RFID tag from the RFID reader coupled to the second antenna. The method can include calculating a second range from the second antenna to the RFID tag based on the second information. The method can include determining the location of the inventory item associated with the RFID tag based at least partly on the first range, the second range, a position of the first antenna, and a position of the second antenna.

In some embodiments of the second aspect, the method can include selecting a third antenna which has received signals from the RFID tag associated with the inventory item, retrieving third information associated with the RFID tag from the RFID reader coupled to the third antenna, calculating a third range from the third antenna to the RFID tag based on the third information, and updating the location of the inventory item associated with the RFID tag based at least partly on the third range and a position of the third antenna. In a further embodiment, determining the location of the RFID tag includes using trilateration.

In some embodiments of the second aspect, the first information can include a first angle of detection and the second information can include a second angle of detection and determining the location can include combining the first range and the second range with the first angle and the second angle.

In a third aspect, a method is provided for installing an overhead antenna inventory and locating system. The method can include providing a first antenna mounted to a first ceiling tile. The method can include positioning the first antenna mounted to the first ceiling tile in an elevated support structure. The method can include providing a second antenna mounted to a second ceiling tile. The method can include positioning the second antenna mounted to the second ceiling tile in the elevated support structure. The method can include coupling the first antenna to a first RFID reader. The method can include coupling the second antenna to a second RFID reader. The method can include coupling the first and second RFID readers to a system configured to identify and locate items associated with electronic tags.

In some embodiments of the third aspect, the first and second antennas comprise patch antennas. In some embodiments of the third aspect, the first and second antennas comprise phased arrays. In some embodiments of the third aspect, the electronic tags comprise passive RFID tags.

In some embodiments of the third aspect, the first and second ceiling tiles comprise a tile that is about 2 ft. by 2 ft. and configured to be mounted in an elevated support structure.

In some embodiments of the third aspect, the first and second RFID readers are the same RFID reader.

### BRIEF DESCRIPTION OF THE DRAWINGS

The drawings are provided to illustrate example embodiments described herein and are not intended to limit the scope of the disclosure. Throughout the drawings, reference numbers may be re-used to indicate general correspondence between referenced elements.

FIG. 1 is a schematic block diagram of some components of an example of an overhead antenna live inventory locating system for inventorying and/or locating items in a store (e.g., department store, grocery store, etc.), warehouse, or other storage area.

FIG. 2A schematically illustrates a side view of some embodiments of an overhead antenna inventory/locating system wherein antennas are mounted in the ceiling.

FIG. 2B schematically illustrates a top view of some embodiments of a location determination process for an electronic tag which may be used by the overhead antenna inventory/locating system of FIG. 1.

FIG. 3 illustrates a flowchart of some embodiments of a method for determining the location of an electronic tag which may be used by the overhead antenna inventory/locating system of FIG. 1.

FIGS. 4A and 4B schematically illustrate a calibration system which may be used to calibrate some embodiments of an overhead antenna inventory/locating system.

FIG. 5 illustrates a flowchart of a calibration routine which may be used to calibrate some embodiments of an overhead antenna inventory/locating system.

FIG. 6 illustrates a layout of overhead antennas in a ceiling according to some embodiments.

FIG. 7 illustrates a perspective view of a patch antenna mounted to a ceiling tile according to some embodiments.

FIG. 8 illustrates a flowchart of an installation method which may be used to install some embodiments of an overhead antenna inventory/locating system.

### DETAILED DESCRIPTION

Various aspects of the disclosure will now be described with regard to certain examples and embodiments, which are intended to illustrate but not to limit the disclosure. Nothing in this disclosure is intended to imply that any particular feature or characteristic of the disclosed embodiments is essential. The scope of protection of certain inventions is defined by the claims. For ease of reference, the description below uses the term “store” in discussing the overhead antenna inventory/locating system. The term “store” can refer to any type of area where products are located, including but not limited to storage areas, warehouses, retailer facilities, etc.

### Examples of Overhead Antenna Inventory/Locating Systems

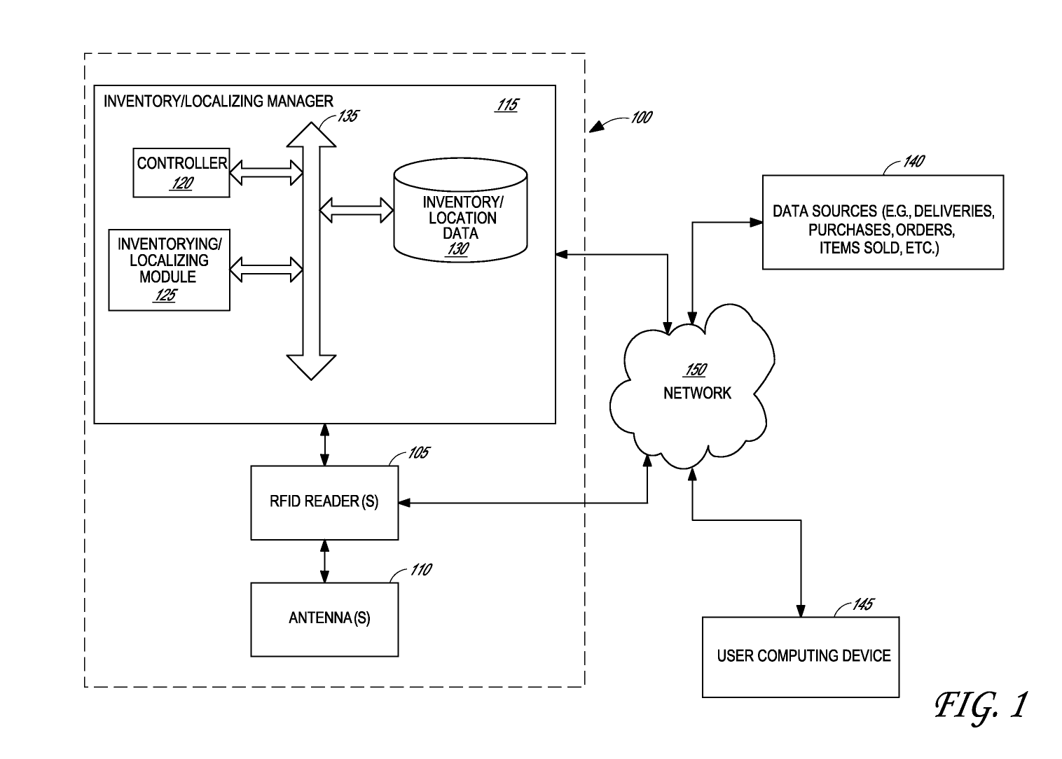

FIG. 1 is a block diagram of an overhead antenna inventory/locating system 100 for inventorying and/or locating items in a store (e.g., department store, grocery store, etc.), warehouse, or other storage area. The system 100 can include one or more RFID readers 105, one or more antennas 110 and an inventory/localizing manager 115. Components of the system 100 can communicate over a network, direct link (e.g., wired or wireless), or other communications link. In addition, the system 100 can be connected to external systems, devices, or data sources via a network 150 or other communications link. In some embodiments, the RFID readers 105 are configured to communicate directly over the network 150.

The overhead antenna inventory/locating system 100 can include one or more RFID readers 105 for controlling antennas 110 and processing signals received from electronic tags. An RFID reader 105 can include an RF transmitter-receiver and can be coupled to one or more antennas 110. The RFID reader 105 coupled to one or more antennas 110 can send signals to and receive signals from the coupled antennas 110 through a multiplexor. The antennas 110 transmit signals to and receive signals from electronic tags. The RFID readers 105 can be configured to interpret the signals received by the antennas 110 from the electronic tags to resolve the tag identification.

The inventory/localizing manager 115 can include one or more controllers 120, an inventorying/localizing module 125 for performing inventory and localizing operations, and data storage 130 for storing inventory and/or location data, such as a list of inventory items, expected inventory items, previous inventory records (e.g., inventory lists from past days), expected location of inventory items, previously recorded locations for items, and other related inventory and/or location data. The components can be connected via a communications medium 135, such as a system bus or network, which can be the same network 150 described above or a different network. For example, the communications medium 135 may be a local area network while the network 150 may be a wide area network. The components of the overhead antenna inventory/locating system 100 can be part of a single computing device or part of one or more computing systems comprising one or more computing devices. For example, in some embodiments, the inventory/localizing manager 115 can be part of the RFID reader 105. In some embodiments, the inventory/localizing manager 115 can be a separate device or devices.

The inventory/localizing manager 115 can be in communication with external data sources 140, which can include store or warehouse data. For example, the inventory/localizing manager 115 can receive inventory-change data, such as data regarding deliveries, purchases, invoices or orders, reports on items, and other inventory-related data from the data sources 140. The inventory/localizing manager 115 can store that inventory-change data in its data storage 130 and can use such data during inventorying/localizing operations. For example, the inventory/localizing manager 115 can receive data associating electronic transmitters or transponders, such as RFID tag identifiers, with particular items, which data the inventory/localizing manager 115 can use to identify and locate items in the storage area.

In some embodiments, the overhead antenna inventory/locating system 100 can be configured to provide inventory and location information for passive RFID tags. The location information can include the position of the passive RFID tag in three dimensions. Passive RFID tags can be less expensive than corresponding active RFID tags and inventory and localizing systems that utilize active RFID tags can be expensive to implement due in part to the cost of active tags. Thus, configuring the system 100 to provide inventory and three-dimensional location information from passive RFID tags can result in a relatively low-cost inventory and localizing solution.

A user computing device 145, such as a desktop computer, laptop, smart phone (e.g., an IPHONE or ANDROID device), tablet or other mobile device, may be able to communicate with the overhead antenna inventory/locating system 100 via the network 150. In some embodiments, the user computing device 145 receives reports, status updates, and/or other messages from the system 100. For example, the system 100 can send an alert to a store manager that the number of units of a particular inventory item is running low. The store manager can then re-order the item by communicating an order to the store's suppliers. In some embodiments, the system 100 may automatically place an order with suppliers. In some embodiments, the system 100 can provide updates on inventory operations to the user computing device 145 that allow the user to track the progress of the inventory operation. This can allow a centrally located manager to monitor one or multiple overhead antenna inventory/locating systems 100 remotely.

In some embodiments, the user computing device 145 can provide instructions to the overhead antenna inventory/locating system 100, such as initiating an inventory operation for the entire store, or for some specified geographical region within the store, or for some specified type of product or category of products within the store; setting a time for an inventory operation; initiating or cancelling an inventory operation; as well as other commands. For example, a store manager can remotely program the system 100 to perform inventory operations. This can be useful when the inventory operations are done after closing, as the store manager can program the system 100 from home or some other location away from the store.

### Example of Overhead Antenna System Mounted in Ceiling

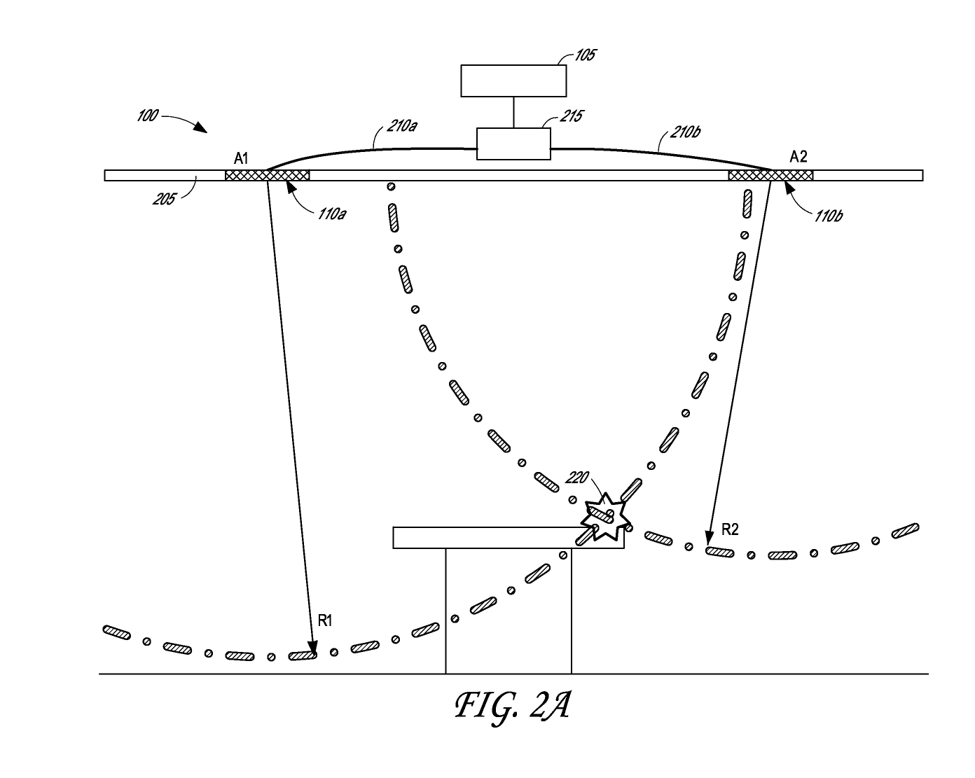

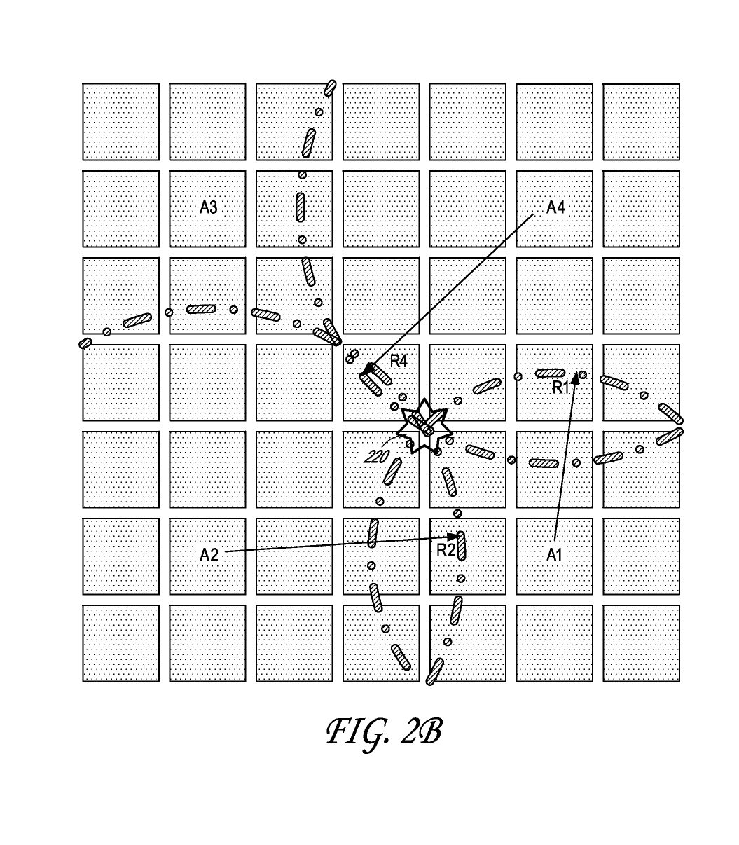

FIG. 2A schematically illustrates a side view of some embodiments of an overhead antenna inventory/locating system 100 wherein antennas 110a and 110b are mounted in the ceiling 205. In some embodiments, the antennas 110a and 110b are mounted at an elevated location outside of, above, and/or below a ceiling. The antennas 110a and 110b are coupled to the RFID reader 105 through cables 210a and 210b or wirelessly. The system can include a multiplexor 215 coupled to the antennas 110a and 110b and the RFID reader 105.

The RFID reader 105 can be capable of reading a variety of RFID tag protocols, including both active protocols and passive protocols, such as EPC GEN-2 or ISO-18000-6. The RFID reader 105 can be in communication with an inventory and/or localizing manager, such as the one described herein in relation to FIG. 1, in order to send and receive location and inventory data.

The RFID reader 105 can be coupled to one or more antennas 110a and 110b through multiplexor 215. The multiplexor 215 can be configured, for example, in a daisy chain style, a tree structure, or a hybrid of the two. In some embodiments, one RFID reader may be coupled to one antenna without a multiplexor between them. The RFID reader 105 can be configured to communicate with the antennas 110a and 110b. Communication can be accomplished via a wired and/or wireless communication link, such as Ethernet, Bluetooth, 802.11a/b/g/n, infrared, universal serial bus (USB), IEEE 1394 interface, or the like. The RFID reader 105 can be configured to communicate with the inventory/localizing manager using similar means. The RFID reader 105 can communicate the inventory data it collects to the inventory/localizing manager. In some embodiments, the RFID reader 105 performs the functions of the inventory/localizing manager; hence the inventory/localizing manager can be incorporated in the reader 105.

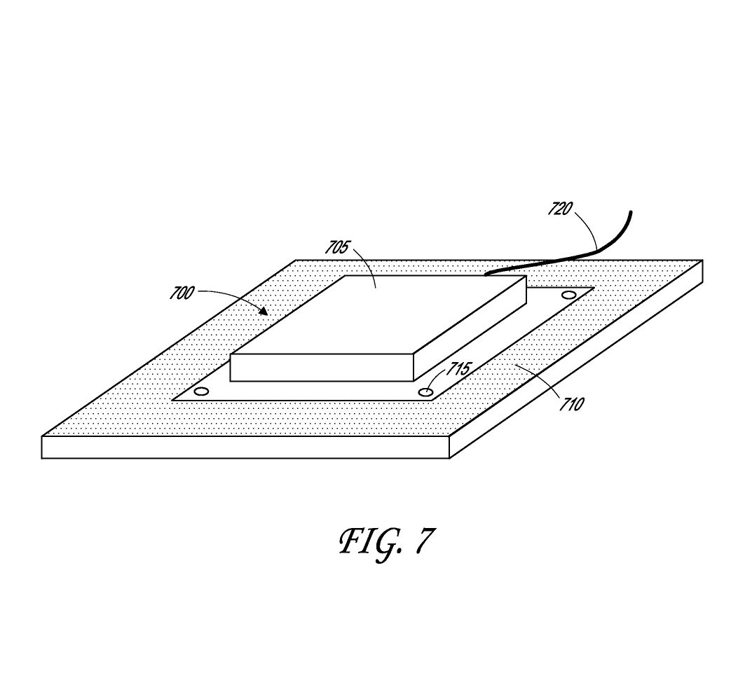

The antennas 110 can be patch antennas. Patch antennas can have a low-profile (e.g., substantially shorter in thickness from top to bottom than in width and/or length), light-weight, and an ability to cover a wide area, making them suitable for installation in ceilings, as described more fully herein with reference to FIG. 7. In some embodiments, the antennas 110 can be directional, omnidirectional, or isotropic antennas. In some embodiments, the antennas 110 can be, for example, phased arrays, dipoles, bidirectional phased arrays, steerable antennas, or any combination of these. Steerable antennas may help in providing directional information related to detected tags permitting a rough determination of their location based on phase angle, received signal strength indicator value, and/or detected angle from the antenna, as more fully set forth herein.

The overhead antenna inventory/locating system 100 can be configured to detect the location of an electronic tag 220. The electronic tag 220 can be an active, passive, or battery-assisted passive RFID tag. The tag 220 can include an integrated circuit and an antenna. The integrated circuit on the tag can be configured to modulate and demodulate the signal from the antennas; store information such as tag identification, stock number, batch number, or the like; and/or collect the transmitted power from the antenna to assist in transmitting a response to the reader's interrogation. The tag 220 can be configured to operate in a low-frequency band, a high-frequency band, an ultra-high-frequency (UHF) band, or other RFID frequency band. For example, a passive RFID tag can be configured to send and receive UHF signals having a frequency of at least about 902 MHz and/or less than or equal to about 928 MHz, or a frequency of at least about 865 MHz and/or less than or equal to about 870 MHz.

The antennas 110a and 110b can be mounted in the ceiling 205 of a store. In some embodiments, one or more antennas can be attached, joined, or affixed to a ceiling tile and placed in a ceiling, or below or above a ceiling. In some embodiments, mounting antennas in the ceiling, or at another elevated location at or near the top region of a room, can provide for greater coverage because the antennas have increased direct-line communication contact and greater detection efficiency because of fewer obstacles between the tags and the antennas. In an elevated location, the antennas are not likely to impede the regular operation of the facility in which they are installed. Installing the antennas in the ceiling can provide for greater aesthetic appeal in that the antennas are hidden and the ceiling tiles can match the existing décor. Installing the antennas in the ceiling can provide easier installation, calibration, and setup. The positions of the antennas mounted in a ceiling can be fixed to a grid such that calibration and/or tag location determination is rendered less complicated. For example, in a typical ceiling in an office or retail establishment, ceiling tiles are configured in a fixed grid arrangement, for example in an approximately 2 ft. by 2 ft. square grid. Other sizes for ceiling tiles can include, for example, about 2 ft. by 4 ft., about 1 ft. by 1 ft., and about 30 in. by 60 in. FIG. 2B schematically illustrates a top view of an example grid pattern with four antennas, A1-A4, situated thereon. By situating the antennas to coincide with ceiling tiles, the regular grid pattern provides for a way to determine the relative geometry and positions of the antennas. For example, in FIG. 2B, assuming the ceiling grid follows a regular 2 ft. by 2 ft. pattern, antenna A1 is 8 ft. from antennas A2 and A4, and about 11.3 ft. from antenna A3. As described herein, this can render the antenna installation, as well as the tag location determination and calibration routines, less complex.

### Example of Location Determination

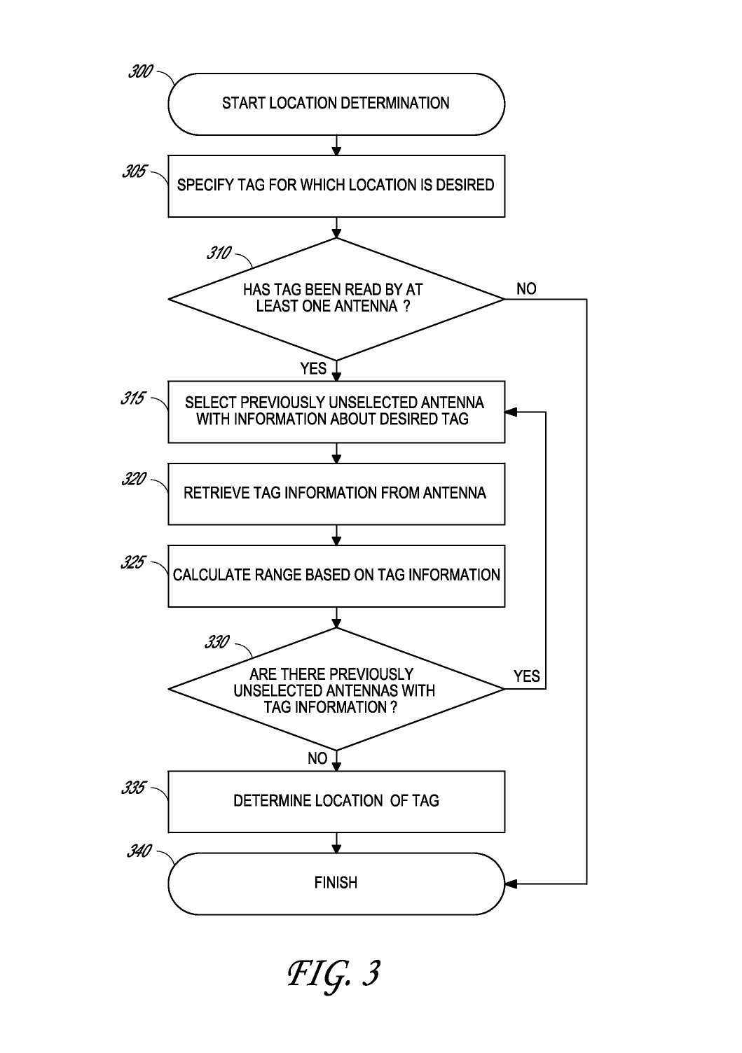

FIG. 3 illustrates a flowchart of some embodiments of a method 300 for determining the location of an electronic tag which may be used by the overhead antenna inventory/locating system 100 of FIG. 1. To simplify the description below, reference is made to a localization system that can be used perform to various steps of the method 300. The localization system can comprise, for example, the overhead antenna inventory/locating system 100, the inventory/localizing manager 115, the inventorying/localizing module 125, the controller 120, one or more RFID readers 105, an external system, such as data sources 140 or the user computing device 145, or any combination of these. In addition, the method 300 will be described in relation to the system in FIG. 1 and embodiments as illustrated in FIGS. 2A and 2B. However, the use of the method 300 should not be construed to be limited to use solely in conjunction with these embodiments.

In block 305 the localization system specifies a tag 220, the location of which is requested. In some embodiments, the specification of the tag 220 can be an automated process. For example, the overhead antenna inventory/locating system 100 can perform a routine inventory procedure to attempt to locate and identify all tags within its range. During this procedure, all tags read by the inventory system 100 can be specified in turn so that they may be processed to determine their location. In some embodiments, the specification of the tag 220 can be selected through the localization system by a user, such as a store manager, a clerk in a retail establishment, or an employee in a warehouse. For example, the location of a box containing a certain product can be requested by a warehouse manager through the localization system. In some embodiments, the specification of the tag 220 can occur due to the satisfaction of a defined condition. For example, the location of all products in a store can be requested at the beginning of a specified time interval, such as the beginning of each hour during store operations or at the end of store operations each day. As another example, all tags sharing certain characteristics, like styles of clothing, can be specified when the inventory/localizing manager 115 signals to the localization system that there are fewer than a certain number left in stock. In some embodiments, the act of specifying the tag 220 can cause the localization system to search through recent read data to determine whether the tag 220 has been read by the system 100. In some embodiments, the act of specifying the tag 220 can cause the overhead system 100 to transmit signals in an attempt to read the specified tag 220. More than one tag can be specified by the localization system, in which case the method 300 can be repeated for each tag specified.

The system 100 can identify how many units of a particular item remain and where they are located. In some embodiments, a customer-usable station or kiosk can be provided in the store or over an electronic network (such as the Internet) to report to customers what inventory exists in a particular store and/or where it is located. This information can also be made available to a customer-operable portable electronic device (such as a smartphone, tablet computer, or lap-top computer). In some embodiments, a computer-based application can permit a customer to input a shopping list of items, and the electronic device can retrieve and/or calculate, and then display information regarding an efficient shopping route through the store for retrieving the desired items in sequence, sometimes referred to as a Personal Shopping Assistant (or “PSA”). In some embodiments, the system 100 can interface with PSAs to provide the location and inventory information so that an efficient route can be created.

In some embodiments, electronic tags can be used to track the movement of shoppers or customers within a store to learn traffic patterns and bottlenecks. Electronic tags can be placed on shopping carts, bags, baskets, or the like, and the system 100 can be configured to track the movement of these tags through the store. This information can be made available to store managers. In some embodiments, a computer-based application can permit a store manager to visualize the traffic patterns of customers in a particular store. The system 100 can be configured to track the movements of shoppers or customers using relatively inexpensive passive RFID tags. The use of relatively low cost passive RFID tags may allow a user to incorporate more tags to acquire more information, thus potentially improving the information to the store manager or other end user.

In block 310 the localization system determines whether the tag has been read by at least one antenna. To make this determination, the localization system can flag all instances of the specified tag 220 in incoming data or in stored data. In some embodiments, the localization system searches for stored data over a specified time interval. For example, the localization system can look at data from the previous minute to attempt to locate the specified tag 220. The time interval can be any time duration and can be determined by the system, by a user, or can be a parameter of the overhead inventory system 100. Similarly, the localization system can request that the overhead system 100 perform a single scan or a series of scans over a time interval during which the localization system attempts to identify the specified tag 220. The localization system can analyze the data to determine whether the specified tag 220 appears in the data. If not, no location determination is made and the system proceeds to block 340. If there is at least one antenna that has read the specified tag 220, the localization system compiles a list of the antennas that have read the tag 220. For example, in FIG. 2A antennas A1 and A2 are illustrated as reading the specified tag 220. In this scenario, the localization system would list antennas A1 and A2 as having read the specified tag 220 and proceed to block 315. In another example, illustrated in FIG. 2B, antennas A1, A2, and A4 are depicted as having read the specified tag 220. Antenna A3, on the other hand, did not read the specified tag 220, possibly because it was shielded, out of range, or antenna A3 malfunctioned. In this scenario, the localization system would list antennas A1, A2, and A4 as having read the specified tag 220 and proceed to block 315.

In block 315 the localization system selects a first antenna that has read the specified tag 220. For example, in the scenario depicted both in FIGS. 2A and 2B, the localization system could begin with antenna A1. The order of the list of antennas compiled in block 310 can be random, ordered according to a received signal strength indicator value (“RSSI”), in chronological order according to read time, designated by a fixed database in memory or software, or the like.

In block 320 the localization system retrieves the information about the specified tag 220 as read by the selected antenna. The tag information can include, for example, tag ID number, antenna number, channel number, transmission power, frequency, RSSI value, date and/or time of detection, phase angle, number of reads, or any combination of these. In some embodiments, the antenna can be a steerable antenna and the tag information can include information about the relevant angle of the antenna when the antenna read the tag 220. The tag information can be retrieved from storage or it can be passed directly to the localization system as it is read.

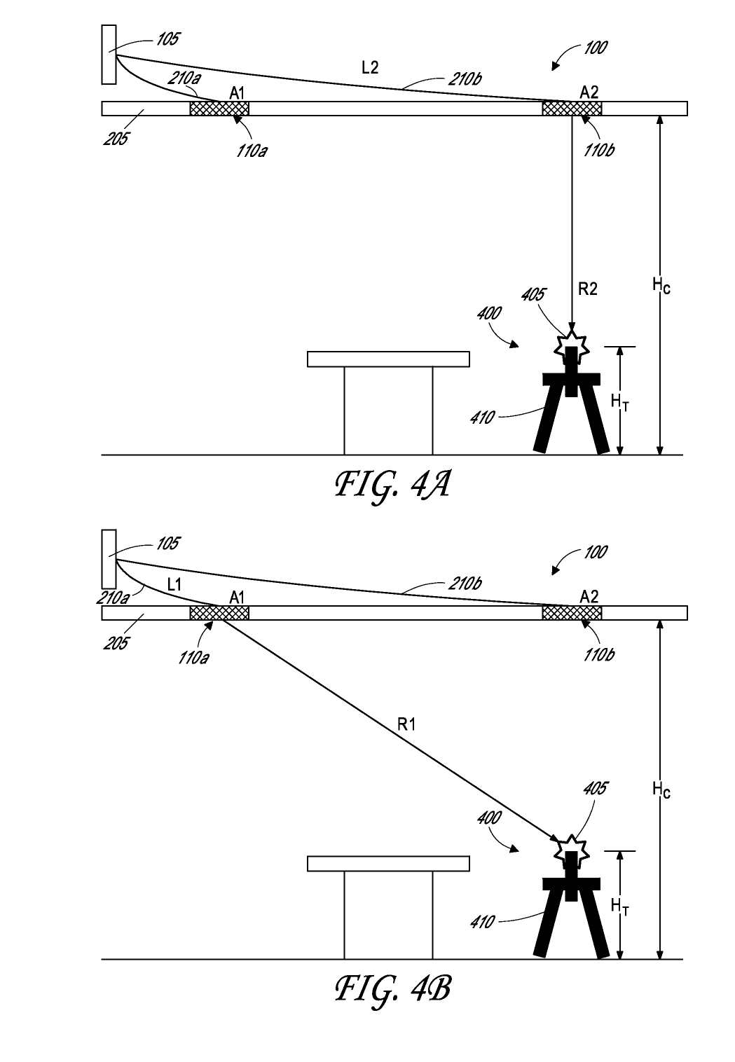

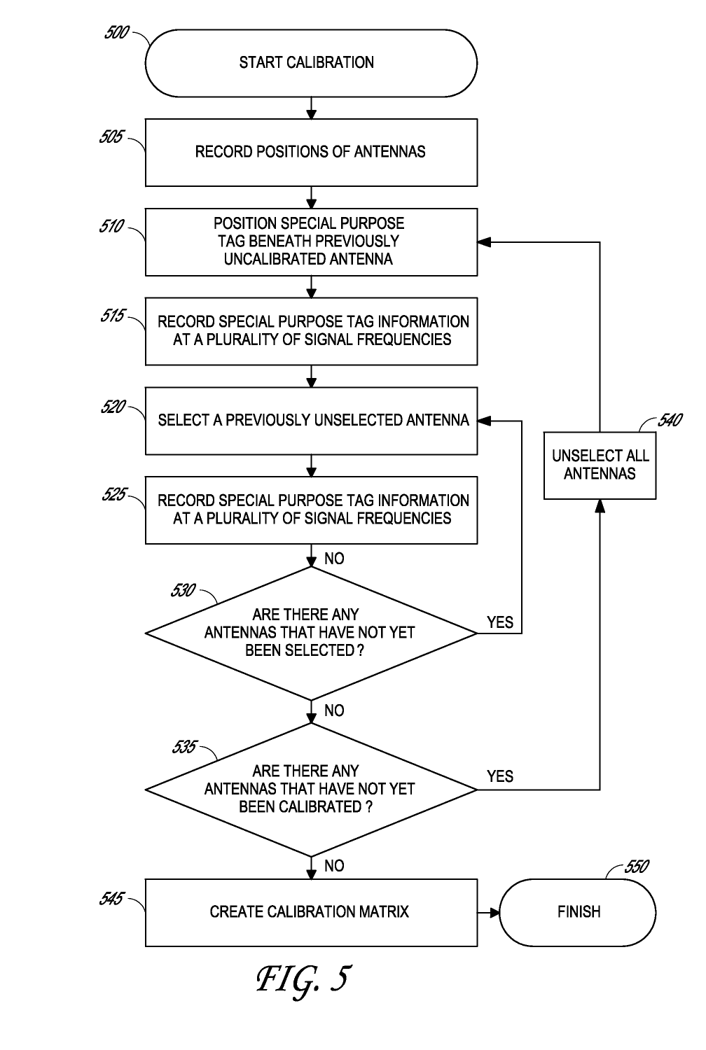

In block 325 the localization system calculates the range of the tag 220, or the distance from the antenna to the tag 220, based at least in part on the tag information retrieved in block 320. In some embodiments utilizing passive electronic tags, the range can be calculated by solving a series of phase angle equations at different frequencies. The phase angle at a given frequency is related to the propagation distance from the signal source to the tag 220 and back to where the signal is read. The total propagation distance can be represented as an integer number of wavelengths plus a remainder, which corresponds to the phase angle. For example, in a system where the frequency of the antennas can change, the phase angle of the return signal from the tag 220 can be reported by the reader at a plurality of frequencies. For a given distance between the antenna and the tag, the phase angle is a linear function of the frequency and the derivative of that function corresponds to the propagation distance. In some embodiments, the calculation of the propagation distance includes the distance the signal propagates between the antenna and the RFID reader. Calibration data can be used to correct for this additional length, as described herein with reference to FIGS. 4A, 4B, and 5.

In some embodiments, the electronic tag is a passive RFID tag that reflects the carrier signal back to the transmitting antenna. The passive RFID tag can be configured to be responsive to signals broadcast in the range of at least about 902 MHz and/or less than or equal to about 928 MHz, or of at least about 865 MHz and/or less than or equal to about 870 MHz. The frequency of the antenna signal can change within the defined range about every 400 ms or less, which conforms to FCC regulations related to signals broadcast in the UHF range between 902 MHz and 928 MHz. Thus, a system that utilizes the UHF signals in that range will transmit at a variety of frequencies that change relatively rapidly. In some embodiments, depending on the spread of frequencies, range can be calculated with reasonable accuracy based on the method described herein above with a plurality of data points, such as at least two data points, at least three data points, at least four data points, or at least five data points.

In block 330 the localization system determines whether there are additional antennas in the list compiled in block 310. If so, the system returns to block 315, moving to the next antenna on the list. If a range has been calculated for each antenna on the list, the localization system proceeds to block 335.

In block 335 the localization system determines the position of the specified tag 220. The position can be determined relative to the physical layout of the store and/or relative to the antennas in the overhead system 100. Based on the range information calculated in block 325 for each antenna, the localization system can attempt to determine the position of the tag 220. One method of determining the position of the tag is based on intersecting spheres with a radius equal to the range calculated for each antenna. For example, referring to FIG. 2B, the localization system determines that the range from antenna A1 to the tag 220 is R1. Similarly, the system determines that the ranges from antennas A2 and A4 to the tag 220 are R2 and R4, respectively. The system can then create three spheres with radii equal to the calculated ranges and centered on the respective antennas. Using trilateration, the system can then determine the position of the tag, within some uncertainty, to the position where the three spheres intersect. The intersection of three spheres can produce two points, but in this scenario one of those points would be above an elevated real or imaginary plane, such as above or within the ceiling. This point can be dismissed because the tag is known to be beneath this elevated plane, such as the ceiling, and the position can be uniquely determined relative to the three antennas.

In another example, referring to FIG. 2A, the localization system determines that the range from antenna A1 to the specified tag 220 is R1. Similarly, the system determines that the range from antenna A2 to the tag 220 is R2. The intersection of these spheres represents a locus of possible locations for the tag 220. The intersection of two spheres can be represented by a circle. The possible positions of the tag can be reduced from anywhere along the circle (or semi-circle if limited to positions below the ceiling) if the tag 220 is known to reside at a particular height, as illustrated in FIG. 2A. In this scenario, the locus of possible positions can be reduced from a circle to two arcs along that circle at the known height.

Another method of determining the position of the tag 220 includes using triangulation. To utilize triangulation, the localization system can use angular information from the antennas. For example, if the antennas 110 in the overhead system 100 comprise a steerable antenna array, then the transmission angle of the antenna that detected the tag 220 can be included in the tag information retrieved in block 320. Combining the angular information with the range information determined in block 325, the position of the tag 220 can be determined. Similarly, if the tag 220 is detected by a single steerable antenna, the localization system can determine the position of the tag based on the calculated range for that antenna and the angular information.

The position of the tag can be specified relative to the antennas or relative to the physical layout of the store. In some embodiments, specialty location tags are attached in a non-mobile manner to certain landmarks within a store. For example, specialty tags can be placed or affixed at exits, along walls, near dressing rooms, along shelves, or any combination of these. The overhead inventory system 100 can detect these tags for which the absolute position is known. Based on these readings, the overhead inventory system 100 can create a map of the store and calculate positions of tags relative to this generated map. For example, the position of a specified tag 220 can be reported as a relative position from a landmark within the store, like 10 ft. south from the northwest exit and 3 ft. off the floor. As another example, the position can be reported using Cartesian coordinates in a relative grid, such as reporting the position to be 8 ft. S, 2 ft. E, and 5 ft. off the floor. The position can be reported in three dimensions, for example, using relative or absolute positions, using Cartesian coordinates, spherical coordinates, cylindrical coordinates, or any combination of these. The specialty tags can be permanent or can be removed after the system has been installed and/or calibrated. Specialty tags can be electronic tags that respond with a unique identification when interrogated by a reader. For example, the specialty tags can be passive RFID tags that respond to interrogation with a fixed serial number that does not coincide with any other products in the store.

In block 340 the localization system terminates the method and reports the results. The results can be reported to the inventory/localizing manager 115, RFID readers 105, external data sources 140, a user computing device 145, or any combination of these. In some embodiments, the method 300 is performed in near-real time and the locations of tags can be reported back to the requesting system or user sufficiently quickly to provide a near real-time map of tag locations.

Several other methods for ranging can be used in addition to or instead of the ranging methods described above. These additional methods can add to the accuracy of the determined tag position. Some embodiments can include measuring the return signal strength from the tag 220 and correlating the signal strength with the distance. For example, as depicted in FIG. 2A a stronger signal in antenna A2 from the tag 220 can indicate the tag is relatively closer to the antenna A2 compared to antenna A1.

In some embodiments, the localization system compares the signal strength of a first, unknown electronic tag with a second tag with a known location to determine the range. For example, if the first tag's signal is stronger than the second tag, where the second tag has a determined range of 20 feet, then the localization system can estimate that the first tag is closer than 20 feet. The localization system can use additional known tags to refine the estimate. For example, if the first tag is weaker than a third tag with a determined range of 10 feet, the inventory system 100 can refine the estimate to within 10-20 feet. A fourth, fifth, or even more known tags can be used to further refine the estimate.

Other methods can include incrementally varying the power from the reader to an antenna and determining the range based on where the readings from the tag 220 drop out or diminish below a specified signal strength. For example, if half power from the reader corresponds to a detection range of 20 feet, while full power corresponds to a range of 30 feet, the tag signal dropping out at half-power indicates the tag is between 20-30 feet from the reader.

In some embodiments, the distance between the antenna 110 and the tag 220 can be calculated using phase ranging. For example, phase readings can be collected by monitoring reply signals from the RFID tags corresponding to interrogation signals at multiple frequencies and a common interrogation signal beam direction. The measured phase and frequency data can be compared with theoretical phases calculated with respect to the same frequencies over a range of positions corresponding to a beam extent of the interrogation signal in order to determine the distance.

In some embodiments, the electronic tags are active RFID tags. Finding the range between the antenna 110 and the active tag 220 can be calculated using time of flight information. Using this method, the range is calculated based on the propagation speed of the RF signal and the time of flight of the signal. In some embodiments, range is calculated based on differential time of flight. Using this method, range is calculated based on the difference in time that a signal is received signal at two antennas. The locus of possible positions for the active tag 220 is then a hyperbola with the two antennas at the foci. An additional antenna can provide additional differential time of flight information and constrain the location of the active tag 220 to a certain location.

### Example Calibration Systems and Methods

FIGS. 4A and 4B schematically illustrate a calibration system which may be used to calibrate some embodiments of an overhead antenna inventory/locating system 100, such as the one depicted in FIG. 2A. Referring to FIG. 4A, antennas 110a and 110b can be installed in a support structure 205 in a store, such as in a ceiling, walls, shelving, rafters, or the like. The antennas 110a and 110b can be coupled to a RFID reader 105 through cables 210a and 210b.

The calibration system 400 can comprise a special purpose electronic tag 405 and a support 410 for the tag 405. The special purpose tag 405 can comprise an RFID tag that is passive, active, or battery-assisted passive. The special purpose tag 405 can be similar to a typical RFID tag, differentiated in that the tag 405 responds with a designated code when interrogated by a RFID reader. The support 410 can include any means for securing the special purpose tag in a fixed position and orientation, such as a tripod, stool, ladder, chair, table, desk, box, etc. In some embodiments, the calibration system 400 includes means for aligning the special purpose tag relative to an antenna. For example, the means for aligning the special purpose tag can include a laser or laser pointer, a visual targeting system, a physical extension of the support 410, acoustic waves, or any combination of these.

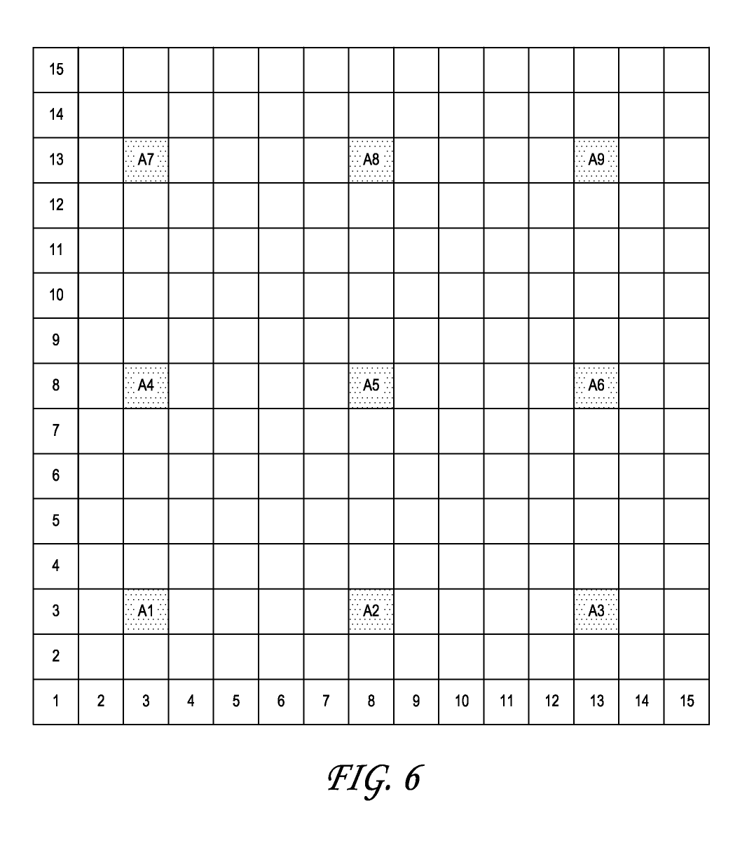

FIG. 5 illustrates a flowchart of some embodiments of a calibration routine 500 which may be used to calibrate an overhead antenna inventory/locating system 100 like the one depicted in FIGS. 4A and 4B. In block 505 the positions are recorded of all the antennas to be calibrated. For example, referring to FIG. 6, antennas installed in a ceiling using ceiling tiles can be arranged in a regular grid pattern. The grid pattern can be designated such that the first row of tiles can be designated row 1, the second row 2, and so forth. The columns can be similarly designated. Thus, an antenna can have a unique position recorded according to its location in the grid, see Table 1.

TABLE 1
Ceiling-mounted antenna positions

| Antenna | X-Tile | Y-Tile |
|---|---|---|
| A1 | 3 | 3 |
| A2 | 8 | 3 |
| A3 | 13 | 3 |
| A4 | 3 | 8 |
| A5 | 8 | 8 |
| Etc. | | |

In block 510 the special purpose tag 405 is positioned beneath a designated antenna. The tag 405 can be positioned in some other location, but the calibration routine may be simplified by placing the tag 405 beneath the antenna. To position the tag 405, the support 410 securing the tag 405 is aligned vertically under the antenna. In some embodiments, the tag 405 is aligned using a laser or laser pointer oriented substantially vertically to visually indicate the position of the tag 405 relative to the antenna. For example, the support 410 and special purpose tag 405 can be positioned directly beneath antenna A2, as depicted in FIG. 4A.

Once the tag 405 is positioned in the desired location, the tag 405 can be interrogated by the RFID reader through the designated antenna at a variety of frequencies in block 515. For example, the antenna A2 can transmit signals ranging from at least about 902 MHz and/or less than or equal to about 928 MHz with the transmission frequency hopping among 50 designated channels within that band about every 400 ms or less. The tag information received by the antenna A2 from the tag 405 can be transmitted to the reader 105. The reader 105 can record the tag information which can include, for example, the tag identification, antenna number, the transmission frequency, the phase angle, the received signal strength, or any combination of these.

In blocks 520 and 525 another antenna is selected and used to interrogate the special purpose tag 405. The tag information received by the newly selected antenna is recorded. For example, referring to FIG. 4B, antenna A1 is used to interrogate the special purpose tag 405 while it is positioned beneath antenna A2. The tag response is passed from the antenna A1 to the RFID reader 105. In block 530 a previously unselected antenna is selected to interrogate the special purpose tag. If all antennas in the system have been previously selected to interrogate the tag 405, then the tag 405 and support 410 can be moved to the next designated antenna to calibrate. The process begins anew and all previously selected antennas are unselected in block 540.

After completion of antenna calibration, a calibration matrix is created in block 545. Creating the calibration matrix can include calculating the range from each antenna to the special purpose tag 405 for each tag position, see Table 2. The ranges can be calculated using the methods described herein. For example, the range can be calculated using the phase angles reported by the reader 105 at various frequencies, as set forth above in relation the location method in FIG. 3. If a tag is not read by an antenna, then that entry in the calibration can be left blank. This information can be useful to understand the limitations of the system.

TABLE 2
Ranges measured to special purpose tag

| Antenna | A1 | A2 | A3 | A4 | A5 | Etc. |
|---|---|---|---|---|---|---|
| A1 | 7.5′ | 12.5′ | 21′ | 12.5′ | 16′ | |
| A2 | 12.5′ | 7.5′ | 12.5′ | 16′ | 12.5′ | |
| A3 | 21′ | 12.5′ | 7.5′ | 23.5′ | 16′ | |
| A4 | 12.5′ | 16′ | 23.5′ | 7.5′ | 12.5′ | |
| A5 | 16′ | 12.5′ | 16′ | 12.5′ | 7.5′ | |
| Etc. | | | | | | |

Using the phase angle method, the phase angle reported by the reader 105 is a function of the length of the cable between the reader and the antenna and the various couplings, multiplexors, and filters in the path. In FIG. 4A this length is designated L2 for antenna A2 and in FIG. 4B it is designated L1 for antenna A1. The phase angle is also a function of the distance from the antenna to the tag. This distance is designated R2 for antenna A2 in FIGS. 4A and R1 for antenna A1 in FIG. 4B. The total propagation distance, D, is then 2(L2+R2) for antenna A2 and 2(L1+R1) for antenna A1. As described above, calculating the derivative of the phase angle as a function of frequency corresponds to the total propagation distance of the signal, D. The distance from the antenna to the tag can also be calculated based on the physical layout of the system, the height of the antenna, and the height of the tag 405. For example, in FIG. 4A the distance R2 is the difference between the ceiling height, H_{C}, and the height of the tag, H_{T}. Thus, the equation D=2(L2+R2) can be solved for L2 and used as a calibration constant in the overhead antenna inventory/locating system 100. As an example, a calibration matrix indicating the range from the antenna to the tag 405 has been calculated in Table 2 for the antenna positions depicted in FIG. 6 and using a ceiling height of 10 ft., 2 ft. by 2 ft. tile spacing, and a tag height of 2.5 ft. In some embodiments, the calibration matrix can include the received signal strength indicator values. In some embodiments the calibration matrix will lack the symmetry illustrated in Table 2.

The calibration matrix can be used to analyze areas of coverage for the various antennas in the system 100. The calibration can provide an expectation value for the expected signal strength from a tag situated a certain distance from a given antenna. The calibration matrix can provide information related to the signal path from one zone to another. In some embodiments the ranges calculated during the calibration routine and included in the calibration matrix can be compared to the ranges determined from measuring the height of the tag 405, H_{T}, the height of the ceiling, H_{C}, and the distances between the antennas. For example, the distance between the tag and antenna A1 in FIG. 4B can be calculated from geometrical arguments as being 12.5 ft. (using the distance from A1 to A2 as 10 ft., H_{T}=2.5 ft. and H_{C}=10 ft.). This number can be compared to the value determined following the range calculation method outlined above using the phase angle of the return signal from the tag 405. The geometric calculation can be taken as the standard and a correction factor can be calculated for that antenna corresponding to the deviation of the range calculated using the tag information from the geometric calculation. This procedure can be followed for each antenna in the system.

### Example Patch Antenna Mounted in a Ceiling Tile

FIG. 7 illustrates an example of a patch antenna 700 mounted to a ceiling tile 710 according to some embodiments. The patch antenna 700 comprises a patch antenna housing 705 that can be mounted to a ceiling tile 710. The patch antenna 700 can be part of an overhead antenna inventory/locating system as described herein above. The patch antenna 700 can be coupled to an RFID reader through cable 720. The cable 720 can be configured to provide electromagnetic signals sufficient to drive the antenna 700 at the desired frequency, power, and polarization. The cable 720 can be configured to convey signals to the RFID reader from the antenna 700.

The patch antenna 705 can be mounted to the ceiling tile 710, for example, using mounting interfaces 715. In some embodiments, the patch antenna housing 705 can be mounted to the ceiling tile 710 using a permanent connection such as, for example, adhesives, thermal bonding, welding, clamps, friction, fasteners, rivets, nails, screws, or any combination of these.

In some embodiments, using patch antennas in an overhead antenna inventory/locating system can have many advantages. For example, patch antennas can be configured to emit a greater fraction of radiated energy in the forward direction, toward the inventory to be detected, losing less energy to radiation emitted above the antennas where no electronic tags are located. It may be desirable to more efficiently use the radiated power of the antennas to detect inventory as opposed to radiating energy in directions where tags will not likely be found. Thus, the system can efficiently utilize the supplied power to perform inventory tracking and locating functions.

Patch antennas can be configured to have a broad radiation pattern compared to some directional antennas. This can be advantageous for covering a large field of view near the antenna, useful where the antenna is mounted in a low ceiling or there are electronic tags close to the antennas. A broad coverage area can reduce the number of antennas necessary to provide sufficient coverage by an overhead antenna inventory/locating system.

Patch antennas can be configured to emit linear or circular polarized electromagnetic radiation. It can be advantageous to emit circular polarized radiation in an RFID system because a circularly polarized electromagnetic wave will interact with a linear antenna, like one found in a passive RFID tag, tilted at any angle in the plane perpendicular to the direction of wave propagation, increasing the probability that the tag will be detected. To configure a patch antenna to emit circularly polarized radiation can be an inexpensive process. Therefore, it may be advantageous to increase the detection efficiency of an overhead antenna inventory/locating system by using circularly polarized patch antennas because it does not significantly increase the cost of the system.

Patch antennas can be configured to have a low profile. One possible difficulty in installing an antenna in an elevated structure, such as a ceiling, can be that there is little space for large structures due to the presence of HVAC ductwork; electrical conduits; lighting fixtures; water, waste, and gas pipes; fire sprinkler systems; alarm systems; and other infrastructure support systems. Thus, it may be advantageous to install an antenna with a low profile in the elevated structure to avoid interfering with existing infrastructure.

Patch antennas can be light-weight due to their relatively small size, few components, and light-weight materials used in their construction. To mount an antenna in a ceiling, for example, it may be advantageous to mount the antenna in an existing ceiling tile or to fabricate a tile that blends in with the existing tile. This tile may not be able to support heavy structures so it may be desirable to fabricate a light-weight antenna that a ceiling tile can support.

Patch antennas allow for installation in the ceiling using ceiling tiles as described above. Thus, installation of the antennas can be a matter of replacing an existing ceiling tile with one that has a patch antenna mounted thereon, reducing the need for professional installation and costs associated therewith. Other advantages of ceiling-mounted patch antennas are described herein in relation to locating tags, taking inventory, and calibration of the system.

### Example Installation Methods

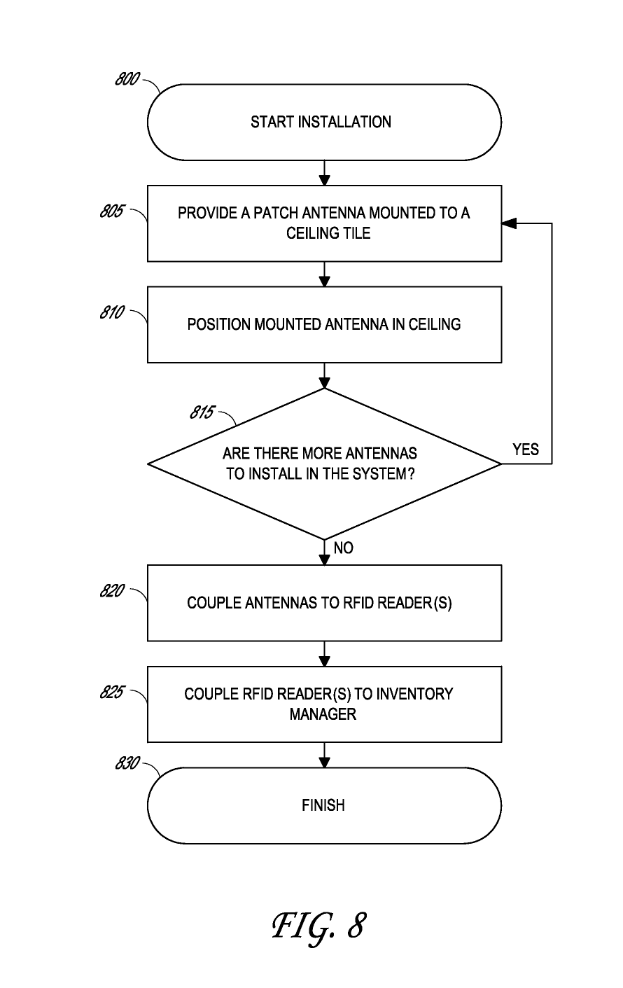

The overhead antenna inventory/locating system 100 can be installed in an elevated support structure in a store, warehouse, retailer facility, or the like. For example, the antennas can be installed in a ceiling of a store using ceiling tiles with antennas mounted on them, as described herein in relation to FIG. 7. FIG. 8 illustrates a flowchart for an installation routine 800 according to some embodiments which can be used to install an overhead antenna system 100 employing the use of ceiling tile-mounted patch antennas as illustrated in FIG. 7.

In block 805 a patch antenna mounted to a ceiling tile is provided. The patch antenna can be mounted to the ceiling tile using adhesion, welding, thermal bonding, clamps, fasteners, or the like. The ceiling tile can match the style of the existing ceiling tile in the location the system 100 is to be installed. In some embodiments, the ceiling tile is different from the existing ceiling tile to indicate that it has an antenna mounted thereon. The ceiling tile can be of any suitable size including, for example, about 2 ft. by 2 ft., about 2 ft. by 4 ft., about 30 in. by 60 in., or about 1 ft. by 1 ft.

In block 810 the antenna mounted to the ceiling tile can be positioned in the ceiling. This step can comprise removing an existing ceiling tile and replacing it with the ceiling tile with the mounted antenna. Positioning the ceiling tile can comprise selecting a location for the tile that optimizes or improves the coverage of the antenna relative to the electronic tags that are to be read and detected. Positioning the ceiling tile can comprise selecting a location for the tile that is at a regular distance interval from a previously installed antenna. For example, the antenna can be positioned such that it is two tiles away from its nearest antenna neighbor.

In block 815 the procedure can be repeated for all remaining ceiling tile-mounted antennas. The location of the remaining antennas can be selected such that the antennas are generally, regularly, or evenly spaced along a grid, such as the layout illustrated in FIG. 6. Other installation configurations are possible as well, depending on the particular application desired. As described herein, the system 100 can be utilized for multiple applications and a particular function may have a more desirable antenna configuration. For example, the antennas can be clustered in regions where overlapping coverage is desired and sparse where little or no coverage is desired. The antennas can be placed along the peripheral of a designated area or at designated positions such as exits or entryways. The antennas can be placed over cash registers or other points of sale.

In block 820 the antennas can be coupled to one or more RFID readers. The antennas can be coupled to one RFID reader through a suitable multiplexor configured, for example, in a daisy chain style, tree structure, or a hybrid of the two. In some embodiments, one antenna can be coupled to one RFID reader. In some embodiments, a plurality of antennas can be coupled to one RFID reader. For example, in some configurations nine antennas are coupled to one RFID reader through a multiplexor. In some configurations less than nine are coupled to one RFID reader, and in some configurations more than nine are coupled to one RFID reader. The RFID reader or readers can be installed in the ceiling as well or may be installed in some other location. As described herein, the antennas can be coupled to the RFID readers through wired or wireless means.

In block 825 the one or more RFID readers can be coupled to the inventory/localizing manager. Communication can be accomplished via a wired and/or wireless communication link, such as Ethernet, Bluetooth, 802.11a/b/g/n, infrared, universal serial bus (USB), IEEE 1394 interface, or the like. The inventory/localizing manager can be part of the RFID reader or a physically distinct unit.

### Example Functionality of the Overhead Antenna Inventory/Locating System

The overhead antenna inventory/locating system 100 can be used to perform an inventory scan of a store or similar location. The inventory scan can include the RFID readers 105 interrogating the tags by transmitting signals from the antennas 110 in the overhead system 100. The RFID readers 105 can collect inventory data on inventory items within the detection ranges of the antennas 110 in the system 100. In some embodiments, the RFID readers 105 detect RFID tags associated with inventory items. The collected inventory data can include any one or any combination of data transmitted from the RFID tags, such as identification data for the inventory items (e.g., item ID, RFID ID or item description), data from the RFID readers 105, and/or characteristics of the communication link between the reader and the tag, such as phase angle, frequency, receive signal strength, transmit power, bit error rates, Doppler shift, time of flight, differential time of flight, and/or read rate. For example, the readers 105 can record the strength of the signal received from the RFID tags, an estimate of the item location, or other inventory data. As part of the inventory routine in some implementations, the RFID readers 105 determine location data for the inventory items. As discussed above in relation to FIG. 3, many different methods can be used to determine the location of the inventory items based on the collected inventory data.

In some embodiments, the overhead antenna inventory/locating system 100 may generate X-Y-Z coordinates (e.g., 3-dimensional coordinates) for the inventory items based on the collected inventory data. The system 100 may assign a confidence score or quality measure to the coordinates that indicate the degree of certainty for each estimated location of the inventory item. The confidence score may also be assigned for embodiments using an X-Y or 2-dimensional coordinate system to identify inventory item locations. The coordinates generated by the system 100 can represent the absolute location of inventory items within the store.

The system 100 can be used to reconcile inventory location or otherwise determine if something is out of place. For example, the system 100 may have received expected location information for the items in the store, and can use that information to identify items that are not in the expected location. This can help the store organize items or find lost items. For example, an inventory clerk can receive a misplaced item report from the inventory system 100 and the inventory clerk can replace the misplaced items in their correct location.

The system 100 can be used to reconcile inventory. For example, the overhead system 100 can conduct an inventory scan and compare the results of the scan against a previous inventory scan or a downloaded inventory list. The overhead system 100 can be configured to compare these lists and report the results. For example, the system can be configured to indicate to a clerk or manager when a particular item has reached a predetermined level, indicating a possible need to reorder items or restock shelves.

In some embodiments, the system 100 generates expected location information or “golden tag placement” for the items in the store by recording the location of items during an inventorying operation (e.g., the first such operation at the store) and using that expected location information as a baseline for reconciling inventory location during future inventorying operations. For example, the system 100 can determine if items have moved or if the items in the store have changed since its last inventorying operation by comparing a current scan with the golden tag placement. The system 100 can then report those changes to users of the system, such as the store manager or other store employees.

In some embodiments, the overhead antenna inventory/locating system 100 can be configured to provide electronic article surveillance (“EAS”) functionality. The EAS functionality can comprise signaling another system when the position of an article is determined to be outside or inside a defined region. For example, when an article's position is determined to be outside an exit, that article can be checked against recent purchases or similar database. If the article does not appear in that database, the overhead system 100 can interface with an alarm system to trigger an alarm indicating possible theft.

In some embodiments, the overhead system 100 can provide zone monitoring capabilities. The overhead system can be configured to track the entrance and exit of all articles within a defined region. For example, the area near the dressing rooms in a clothing store can be flagged as an area to monitor. The overhead system 100 can store and present information related to the articles that have entered the dressing rooms and which have exited. Store personnel can access this information to monitor that area of the store.

In some embodiments, the overhead system 100 can be configured to track the movement of tags. The article tracking configuration can include defining a set of articles to track. In some embodiments, the overhead system 100 can be configured to generate an alert or alarm if one of the identified articles shows that it has been moved at all or is outside or inside a defined region. In some embodiments, the overhead system 100 can track the movement of articles by determining their location at various times. This information can be stored, processed, and/or reported to other systems or users.

### CONCLUSION

Many variations on the overhead antenna inventory/locating system 100 described above are possible. For example, while the above description generally describes functions as performed by the RFID reader, at least some of those functions can be performed by the inventory/localizing manager or other component of the overhead antenna inventory/locating system. Likewise, at least some functions described as performed by the inventory/localizing manager system can be performed by the RFID reader. For example, the inventory/localization manager may be incorporated into the RFID reader or the RFID reader can perform at least some calculations or processes for the overhead antenna inventory/locating system using its own systems. In another example, while the above description generally describes RFID tags, other electronic tags can be used by the system.

As described above, the overhead antenna inventory/locating system 100 can be implemented with one or more physical servers or computing machines, such as several computing machines interconnected via a network. Thus, each of the components depicted in the overhead system 100 can include hardware and/or software for performing various features.

The processing of the various components of the overhead system 100 can be distributed across multiple machines, networks, and other computing resources. Moreover, in some embodiments the connections between the components shown represent possible paths of data flow, rather than actual connections between hardware. While some examples of possible connections are shown, any of the subset of the components shown can communicate with any other subset of components in various implementations.

In some embodiments, the overhead antenna inventory/locating system 100 may be configured differently than illustrated in the figures above. For example, various functionalities provided by the illustrated modules can be combined, rearranged, added, or deleted. In some embodiments, additional or different processors or modules may perform some or all of the functionalities described with reference to the example embodiment illustrated in the figures above. Many implementation variations are possible.

In some embodiments, a server computing system that has components including a central processing unit (CPU), input/output (I/O) components, storage, and memory may be used to execute the overhead antenna inventory/locating system 100 or specific components of the overhead system 100. The executable code modules of the overhead system 100 can be stored in the memory of the server and/or on other types of non-transitory computer-readable storage media. In some embodiments, the overhead system 100 may be configured differently than described above.

Each of the processes, methods, and algorithms described in the preceding sections may be embodied in, and fully or partially automated by, code modules executed by one or more computers, computer processors, or machines configured to execute computer instructions. The code modules may be stored on any type of non-transitory computer-readable medium or tangible computer storage device, such as hard drives, solid state memory, optical disc, and/or the like. The systems and modules may also be transmitted as generated data signals (e.g., as part of a carrier wave or other analog or digital propagated signal) on a variety of computer-readable transmission mediums, including wireless-based and wired/cable-based mediums, and may take a variety of forms (e.g., as part of a single or multiplexed analog signal, or as multiple discrete digital packets or frames). The processes and algorithms may be implemented partially or wholly in application-specific circuitry. The results of the disclosed processes and process steps may be stored, persistently or otherwise, in any type of non-transitory computer storage such as, e.g., volatile or non-volatile storage.

The various features and processes described above may be used independently of one another, or may be combined in various ways. All possible combinations and sub-combinations are intended to fall within the scope of this disclosure. In addition, certain method or process blocks may be omitted in some implementations. The methods and processes described herein are also not limited to any particular sequence, and the blocks or states relating thereto can be performed in other sequences that are appropriate. For example, described tasks or events may be performed in an order other than that specifically disclosed, or multiple may be combined in a single block or state. The example tasks or events may be performed in serial, in parallel, or in some other manner. Tasks or events may be added to or removed from the disclosed example embodiments. The example systems and components described herein may be configured differently than described. For example, elements may be added to, removed from, or rearranged compared to the disclosed example embodiments.

Conditional language used herein, such as, among others, “can,” “could,” “might,” “may,” “e.g.,” and the like, is not generally intended to imply that features, elements and/or steps are required for one or more embodiments or that one or more embodiments necessarily include logic for deciding, with or without author input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. Conjunctive language such as the phrase “at least one of X, Y and Z,” unless specifically stated otherwise, is otherwise understood with the context as used in general to convey that an item, term, etc. may be either X, Y or Z. Thus, such conjunctive language is not generally intended to imply that certain embodiments require at least one of X, at least one of Y and at least one of Z to each be present

While certain example embodiments have been described, these embodiments have been presented by way of example only, and are not intended to limit the scope of the inventions disclosed herein. Thus, nothing in the foregoing description is intended to imply that any particular feature, characteristic, step, module, or block is necessary or indispensable. Indeed, the novel methods and systems described herein may be embodied in a variety of other forms; furthermore, various omissions, substitutions and changes in the form of the methods and systems described herein may be made without departing from the spirit of the inventions disclosed herein.

What is claimed is:

1. A system for locating and identifying a plurality of inventory items, each inventory item being associated with an RFID tag, the system comprising:
at least one RFID reader configured to generate RFID interrogation signals and receive RFID response signals;
a plurality of antennas positioned in an overhead support structure and coupled to the at least one RFID reader, wherein each of the plurality of antennas is configured to:
receive from the at least one RFID reader an RFID interrogation signal;
transmit a radio-frequency interrogation signal in response to the received RFID interrogation signal,
receive from one or more RFID tags a radio-frequency response signal, and
send to the at least one RFID reader an RFID response signal in response to the received radio-frequency response signal;
an inventory module coupled to the at least one RFID reader, the inventory module configured to identify, based at least partly on the RFID response signal, each inventory item associated with an RFID tag that generated the radio-frequency response signal that was received by at least one of the plurality of antennas; and
a location module coupled to the at least one RFID reader, the location module configured to determine, based at least partly on the RFID response signal, a location of each inventory item associated with an RFID tag that generated a radio-frequency response signal that was received by at least one of the plurality of antennas.

2. The system of claim 1, further comprising a tracking module coupled to the inventory module and the location module, the tracking module configured to track a location of each of the inventory items based at least partly on identification information received from the inventory module and location information received from the location module.

3. The system of claim 2, wherein the tracking module is configured to provide a location of each of the inventory items as a function of time.

4. The system of claim 1, wherein the plurality of antennas comprise patch antennas.

5. The system of claim 1, wherein the plurality of antennas comprises phased arrays.

6. The system of claim 1, wherein the radio-frequency interrogation signal has a frequency that is in a range between about 902 MHz and 928 MHz.

7. The system of claim 1, wherein the radio-frequency interrogation signal has a frequency that is in a range between about 865 MHz and 870 MHz.

8. The system of claim 1, wherein the plurality of antennas transmits circularly polarized radiation.

9. The system of claim 1, wherein the plurality of antennas transmits RF signals that change frequency every 400 ms or less.

10. The system of claim 1, wherein the plurality of antennas transmits RF signals that change frequency every 4 s or less.

11. The system of claim 1, wherein the overhead support structure comprises a ceiling.

12. The system of claim 11, wherein the plurality of antennas is mounted to ceiling tiles in the ceiling.

13. A method for determining a location of an inventory item associated with an RFID tag using an inventory system wherein the inventory system comprises an RFID reader configured to receive multiple readings from RFID tags associated with inventory items, the RFID reader being coupled to a plurality of antennas configured to transmit and receive signals to and from the RFID reader and RFID tags, and an inventory module configured to identify the inventory items based at least partly on the received signals from the RFID tags, the method comprising:
selecting a first antenna which has received signals from the RFID tag associated with the inventory item;
retrieving first information associated with the RFID tag from the RFID reader coupled to the first antenna;
calculating a first range from the first antenna to the RFID tag based on the first information;
selecting a second antenna which has received signals from the RFID tag associated with the inventory item;
retrieving second information associated with the RFID tag from the RFID reader coupled to the second antenna;
calculating a second range from the second antenna to the RFID tag based on the second information; and
determining the location of the inventory item associated with the RFID tag based at least partly on the first range, the second range, a position of the first antenna, and a position of the second antenna.

14. The method of claim 13 further comprising:
selecting a third antenna which has received signals from the RFID tag associated with the inventory item;
retrieving third information associated with the RFID tag from the RFID reader coupled to the third antenna;
calculating a third range from the third antenna to the RFID tag based on the third information; and
updating the location of the inventory item associated with the RFID tag based at least partly on the third range and a position of the third antenna.

15. The method of claim 14, wherein determining the location of the RFID tag comprises trilateration.

16. The method of claim 13, wherein the first information comprises a first angle of detection and the second information comprises a second angle of detection and wherein determining the location comprises combining the first range and the second range with the first angle and the second angle.

17. A method for installing an overhead antenna inventory and locating system, the method comprising:
providing a first antenna mounted to a first ceiling tile;
positioning the first antenna mounted to the first ceiling tile in an elevated support structure;
providing a second antenna mounted to a second ceiling tile;
positioning the second antenna mounted to the second ceiling tile in the elevated support structure;
coupling the first antenna to a first RFID reader;
coupling the second antenna to a second RFID reader; and
coupling the first and second RFID readers to a system configured to identify and locate items associated with electronic tags.

18. The method of claim 17, wherein the first and second antennas comprise phased arrays and/or patch antennas.

19. The method of claim 17, wherein the first and second ceiling tiles comprise a tile that is about 2 ft. by 2 ft. and configured to be mounted in an elevated support structure.

20. The method of claim 17, wherein the first and second RFID readers are the same RFID reader.
